(19) United States
(12) Patent Application Publication
(10) Pub. No.: US 2025/0350059 A1
(43) Pub. Date: Nov. 13, 2025

(54) CONDUCTIVE COLORS FOR ELECTRICAL CONTACTS

(71) Applicant: Apple Inc., Cupertino, CA (US)

(72) Inventors: Kenneth Michael Bagwell, Santa Clara, CA (US); Michael W. Barnstead, Pleasanton, CA (US); Robert Scritzky, Sunnyvale, CA (US); Christoph Werner, Sunnyvale, CA (US)

(73) Assignee: Apple Inc., Cupertino, CA (US)

(21) Appl. No.: 19/203,030

(22) Filed: May 8, 2025

Related U.S. Application Data
(60) Provisional application No. 63/644,879, filed on May 9, 2024.

(51) Int. Cl. H01R 13/03; C25D 13/06; C25D 13/12; H01R 43/16

(52) U.S. Cl. CPC H01R 13/035; C25D 13/06; C25D 13/12; H01R 43/16

(57) ABSTRACT

Methods of coating contacts to have various colors. The color can be selected to match a color of a portion of a device enclosure for an electronic device housing the contacts. Examples can instead provide methods of coating contacts to have a color to contrast with a color of a portion of the device enclosure. These methods can provide electrical contacts having a low contact resistance and good corrosion and scratch resistance.

### CROSS REFERENCES TO RELATED APPLICATIONS

This application claims the benefit of U.S. Provisional Application No. 63/644,879, filed on May 9, 2024, which is incorporated by reference.

### BACKGROUND

The number of types of electronic devices that are commercially available has increased tremendously the past few years and the rate of introduction of new devices shows no signs of abating. Devices such as tablets, laptops, netbooks, desktops, all-in-one computers, smart phones, storage devices, portable media players, wearable computing devices, navigation systems, monitors, and others, have become ubiquitous.

These electronic devices often include one or more connector receptacles through which they can provide and receive power and data. Power and data can be conveyed over cables that include a connector insert at each end of a cable. The connector inserts can be inserted into receptacles in the communicating electronic devices.

In other electronic systems, contacts on a surface of a first device can be in direct contact with contacts on a second device without the need for an intervening cable. Contacts on a surface of an electronic device can be positioned in a highly visible location. As such, their appearance can be a reflection of the care and quality with which the electronic device has been made. Located where they are, these contacts can further be susceptible to exposure to liquids or other substances that can cause corrosion or discoloration. Contacts at a surface of an electronic device can further be subject to scratches and other types of marring.

Some of these electronic devices can be very popular and can be manufactured in great numbers. Therefore it can be desirable that these contacts be readily manufactured such that demand for the electronic devices can be met. It can also be desirable to reduce the consumption of resources such as rare or precious materials used in their manufacturing.

Thus, what is needed are electrical contacts and their methods of manufacture, where the electrical contacts have a desired appearance as well as a low contact resistance. It can also be desirable that these contacts have good corrosion protection and scratch resistance and be readily manufactured while consuming a reduced amount of resources.

### SUMMARY

Accordingly, embodiments of the present invention can provide electrical contacts and their methods of manufacture, where the electrical contacts have a desired appearance as well as a low contact resistance. These contacts can have good corrosion protection and scratch resistance and can be readily manufactured while consuming a reduced amount of rare or precious materials. These contacts can be located at a surface of an electronic device, at a surface of a connector insert, in a connector insert on a cable, in a connector receptacle on an electronic device, or elsewhere in a connector system.

Contacts on a surface of a device can be in a highly visible location. As such, embodiments of the present invention can provide methods of coating the contacts to have various colors. The color can be selected to match a color of a portion of a device enclosure for the electronic device housing the contacts. For example, the color of the contacts can be chosen to match a portion of the device enclosure that surrounds or is near the contacts. This can provide an electronic device where the contacts and at least a portion of the device enclosure appear to be made of the same material. This uniform appearance can enhance the perceived quality and value of the electronic device.

These and other embodiments of the present invention can instead provide methods of coating contacts to provide a color to contrast with a color of a portion of a device enclosure for the electronic device housing the contacts. This color can be a noticeable color that allows a user to quickly find the contacts for mating with contacts of a second or accessory device. This contrasting color can also be chosen to imply a manufacturing source, or to match other electronic devices, such as a second or accessory device.

In these and other embodiments of the present invention, the contacts can have a specific finish, such as a matte or gloss finish. The color can also have a level of transparency. The contacts can also have more than one color. For example, a logo or other fanciful, identifying, or other information can be conveyed by more than one color on a contact.

These and other embodiments of the present invention can provide electrical contacts having a low contact resistance. For example, these contacts can have a textured surface that includes a plurality of pillars. These pillars can provide a large number of contacting points between the contacts and corresponding contacts on a second or accessory device when the contacts are mated with the corresponding contacts.

In these and other embodiments of the present invention, a contact substrate can be received. The contact substrate can be copper, aluminum, one of their alloys, stainless steel, or other material. The contact substrate can be plastic with a layer of copper or other material plated on a top surface. The plastic can have an affinity for a plating layer. For example, the plastic can be a thermoplastic polymer, such as acrylonitrile butadiene styrene or other material. An electrophoretic deposition coating can be formed on a top surface of the contact substrate. The electrophoretic deposition coating can be an epoxy, an acrylic, paint, or other material. The electrophoretic deposition coating can include one or more pigments to provide the electrophoretic deposition coating with a desired color.

Holes can be formed in the electrophoretic deposition coating. These holes can be formed by sandblasting, chemical etching, photolithography, laser etching, stamping, coining, 3-D printing, metal-injection molding, printing, casting, or they can be formed in other ways. These holes can be formed through the electrophoretic deposition coating to a top surface of the contact substrate. The bottom of the holes can be plated to form a number of pillars, each pillar in a corresponding hole. The pillars can have various shaped cross-sections. For example, they can have circular, square, oval, rectangular, or other shaped cross-section. The plating can be copper or other conductive material. The plating can be such that the pillars extend above a top surface of the electrophoretic deposition coating where they can form an electrical connection with a corresponding contact on a second or accessory device when mated. That is, the top surfaces of the pillars can form electrical pathways with a corresponding contact on a corresponding connector or device when the contact and the corresponding contact are mated. The contacts can also feel like metal since the pillars extend above the top surface of the electrophoretic deposition coating.

One or more plating layers can be formed on the tops of the pillars to help to prevent or reduce marring and corrosion. For example, a layer of copper can be formed to help to planarize a top surface of the pillars. A layer of nickel, which can be electroless nickel, can be plated. A barrier layer can be formed, where the barrier layer is palladium or other material. A top plate of rhodium-ruthenium, rhodium-iridium, platinum-ruthenium, rhodium, or other material or combination of materials can be plated or otherwise placed over the barrier layer. A layer of dark rhodium, where the rhodium is darkened through porosity, can be plated or otherwise placed over the barrier layer. A gold flash layer can be formed over the barrier layer before the top plate is added to improve adhesion. Plating the tops of the pillars instead of an entire top surface of the contact substrate can greatly reduce the amount of area to be plated and can help to conserve resources such as precious metals.

More generally, After the pillars have been formed, one or more plating layers can be applied to the surface of the pillars. For example, a top plate can be formed over the contact to provide corrosion and scratch protection. This top plate can be formed of rhodium-ruthenium, rhodium-iridium, platinum-ruthenium, rhodium, or other material or combination of materials. The top plate can be formed of dark rhodium, where the rhodium is darkened through porosity. A barrier layer can be formed over the contact before the top plate is formed to prevent discoloration of the top plate by the copper substrate. The barrier layer can be tin-copper, nickel, palladium, silver, tin-copper-nickel, copper-nickel, tin-nickel, nickel-tungsten, electroless nickel, or other material. One or more adhesion layers can be applied before or after the barrier layer, or both. These adhesion layers can be a gold flash or other layer. Other layers can also be included. For example, a layer of nickel-tungsten alloy, tin-nickel, electroless nickel, copper-nickel, silver, or other material can be plated or formed over the substrate before the barrier layer. Other combinations, such as a top plate of rhodium-ruthenium, rhodium-iridium, platinum-ruthenium, rhodium, dark rhodium, or other material or combination of materials over silver, palladium, nickel, electroless nickel, a nickel-tungsten alloy, tin-nickel, tin-copper, tin-copper-nickel, copper-nickel, tin-nickel, nickel-tungsten, or other nickel alloy can be used, where one or more gold layers can be included. Layers of gold over nickel can also be used in these and other embodiments of the present invention. Additional steps, such as electro-polishing or copper plating can be performed on the substrate after the holes have been formed and before further plating to smooth areas damaged by the laser. In these and other embodiments of the present invention, these layers can be formed by sputtering, vapor deposition, electroplating, or other method. In these and other embodiments of the present invention, the order of these steps can be varied.

To avoid the appearance of lines or other artifacts in the pattern of pillars, such as light or dark patches, the location of the pillars can be varied or randomized. For example, a laser can have a portion of its position information for some or all of the pillars varied or randomized in order to disperse straight lines or other regular or repeating patterns that might otherwise be visible. In these and other embodiments of the present invention, the diameter of the pillars can be varied or randomized. Also, pillars can be omitted from areas or regions on contacts where such pillars can interfere with the assembly or operation of the contacts. For example, where contacts are located in an injection molded housing, pillars can be omitted from areas or regions that are under or near the injection molded housing.

In these and other embodiments of the present invention, a contact substrate can be received. The contact substrate can be copper, aluminum, one of their alloys, stainless steel, or other material. The contact substrate can be plastic with a layer of copper or other material plated on a top surface. The plastic can have an affinity for a plating layer. For example, the plastic can be a thermoplastic polymer, such as acrylonitrile butadiene styrene or other material. A number of holes can be formed in the top surface of the contact substrate. These holes can be formed by sandblasting, chemical etching, photolithography, laser etching, stamping, coining, 3-D printing, metal-injection molding, printing, casting, or they can be formed in other ways. The holes can have various cross-sections, such as circular, square, oval, rectangular, or other shaped cross-section.

The top surface of the contact substrate can then be optionally plated with copper. A layer of nickel, which can be electroless nickel, can be plated. A barrier layer can be formed, where the barrier layer is palladium or other material. A top plate of rhodium-ruthenium, rhodium-iridium, platinum-ruthenium, rhodium, dark rhodium, or other material or combination of materials can be placed over the barrier layer. A gold flash layer can be formed over the barrier layer before the top plate is added to improve adhesion.

A electrophoretic deposition coating can be formed over a surface of the contact substrate. As before, the electrophoretic deposition coating can be epoxy, acrylic, or other material. The electrophoretic deposition coating can include pigments to provide a specific color for the contact substrate and resulting contact. Excess electrophoretic deposition coating can then be wiped such that raised regions among the holes can form an electrical connection with a corresponding contact on a second or an accessory device.

These steps can be done in a different order in these and other embodiments of the present invention. For example, some or all of the plating of the top plate and associated layers can be done after the holes are filled with the electrophoretic deposition coating and the excess has been removed.

To avoid the appearance of lines or other artifacts in the pattern of boles, such as light or dark patches, the location of the holes can be varied or randomized. For example, a laser can have a portion of its position information for some or all of the holes varied or randomized in order to disperse straight lines or other regular or repeating patterns that might otherwise be visible. In these and other embodiments of the present invention, the diameter of the holes can be varied or randomized. Also, holes can be omitted from areas or regions on contacts where such holes can interfere with the assembly or operation of the contacts. For example, where contacts are located in an injection molded housing, holes can be omitted from areas or regions that are under or near the injection molded housing.

While embodiments of the present invention are well-suited to electrical contacts and their method of manufacturing, these and other embodiments of the present invention can be used to improve the appearance and corrosion resistance of other structures. For example, electronic device cases and enclosures, connector housings and shielding, battery terminals, magnetic elements, measurement and medical devices, sensors, fasteners, various portions of wearable computing devices such as clips and bands, bearings, gears, chains, tools, or portions of any of these, can be covered with coatings, plating, and other layers as described herein and otherwise provided for by embodiments of the present invention. The coatings, plating, and other layers for these other structures can be formed or manufactured as described herein and otherwise provided for by embodiments of the present invention. For example, magnets and other structures for fasteners, connectors, speakers, receiver magnets, receiver magnet assemblies, microphones, and other devices can be improved by structures and methods such as those shown herein and in other embodiments of the present invention. Embodiments of the present invention can be utilized in various industries, including automotive, aerospace, electronics, and jewelry.

In various embodiments of the present invention, the contacts and their connector assemblies can be formed in various ways of various materials. For example, contacts and other conductive portions can be formed by stamping, coining, metal-injection molding, machining, micro-machining, 3-D printing, or other manufacturing process. The conductive portions can be formed of stainless steel, steel, copper, copper alloy, copper titanium, phosphor bronze, palladium, palladium silver, or other material or combination of materials, as described herein. They can be plated or coated with nickel, gold, palladium, rhodium, dark rhodium, ruthenium, or other material, as described herein. The nonconductive portions can be formed using injection or other molding, 3-D printing, machining, or other manufacturing process. The nonconductive portions can be formed of silicon or silicone, Mylar, Mylar tape, rubber, hard rubber, plastic, nylon, elastomers, liquid-crystal polymers (LCPs), ceramics, or other nonconductive material or combination of materials.

Embodiments of the present invention can provide contacts and their connector assemblies that can be located in, or can connect to, various types of devices, such as portable computing devices, tablet computers, desktop computers, laptops, all-in-one computers, wearable computing devices, cell phones, smart phones, media phones, storage devices, keyboards, covers, cases, portable media players, navigation systems, monitors, power supplies, adapters, remote control devices, chargers, and other devices. These contacts and their connector assemblies can provide pathways for signals that are compliant with various standards such as Universal Serial Bus (USB), High-Definition Multimedia Interface® (HDMI), Digital Visual Interface (DVI), Ethernet, DisplayPort, Thunderbolt™, Lightning®, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these interconnect paths provided by these contacts can be used to convey power, ground, signals, test points, and other voltage, current, data, or other information.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates an electronic system according to an embodiment of the present invention; and

FIG. 2 through FIG. 5 illustrate a method of manufacturing contacts according to an embodiment of the present invention;

FIG. 6 through FIG. 9 illustrate another method of manufacturing contacts according to an embodiment of the present invention; and

FIG. 10 and FIG. 11 illustrate a method of avoiding visible patterns on a surface of a contact according to an embodiment of the present invention.

### DESCRIPTION OF ILLUSTRATIVE EMBODIMENTS

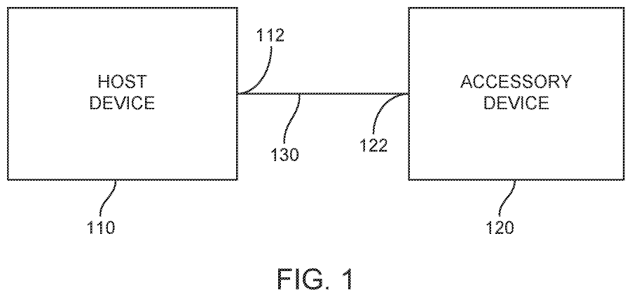

FIG. 1 illustrates an electronic system according to an embodiment of the present invention. This figure, as with the other included figures, is shown for illustrative purposes and does not limit either the possible embodiments of the present invention or the claims.

In this example, host device 110 can be connected to accessory device 120 in order to share data, power, or both. Specifically, electrical contacts (or more simply, contacts) 112 on host device 110 can be electrically connected to contacts 122 on accessory device 120. Contacts 112 on host device 110 can be electrically connected to contacts 122 on accessory device 120 via cable 130. In other embodiments of the present invention, contacts 112 on host device 110 can be in physical contact and directly and electrically connected to contacts 122 on accessory device 120. In still other embodiments of the present invention, one or more optical contacts (not shown) supporting one or more optical connections between host device 110 and accessory device 120 can be included with contacts 112 and 122.

To facilitate a direct connection between contacts 112 on host device 110 and contacts 122 on accessory device 120, contacts 112 on host device 110 and contacts 122 on accessory device 120 can be located on the surfaces of their respective devices. But this location can make them highly visible to users, as well as vulnerable to exposure to liquids, fluids, or other types of contaminants. This location can also make the contacts vulnerable to scratches, marring, or other damage.

Accordingly, embodiments of the present invention can provide methods of coating contacts to provide a specific color. The color can be selected to match a color of a portion of a device enclosure for the electronic device housing the contacts. For example, the color of the contacts can be chosen to match a portion of the device enclosure that surrounds or is near the contacts. This can provide an electronic device where the contacts and at least a portion of the device enclosure appear to be made of the same material. This uniform appearance can enhance the perceived quality and value of the electronic device.

These and other embodiments of the present invention can instead provide methods of coating contacts to provide a color to contrast with a color of a portion of a device enclosure for the electronic device housing the contacts. This color can be a noticeable color that allows a user to find the contacts quickly for mating with contacts of a second or accessory device. This contrasting color can also be chosen to imply a manufacturing source, or to match other electronic devices, such as a second or accessory device.

In these and other embodiments of the present invention, the contacts can have a specific finish, such as a matte or gloss finish. The color can also have a level of transparency. The contacts can also have more than one color. For example, a logo or other fanciful, identifying, or other information can be conveyed by more than one color on a contact, by the positions of pillars or other raised surfaces, or a combination thereof.

These and other embodiments of the present invention can provide electrical contacts having a low contact resistance. For example, these contacts can have a textured surface having patterns of raised areas or ridges. These raised areas or ridges can provide a large number of contacting points between the contacts and corresponding contacts on a second or accessory device when the contacts are mated with the corresponding contacts.

These and other embodiments of the present invention can provide electrical contacts having good corrosion and scratch resistance. For example, a coating to provide color can be placed over a surface of the contact. This coating can be interspersed with conductive pillars or other raised portions that can provide an amount of protection for the contact against corrosion or scratches. Examples are shown in the following figures.

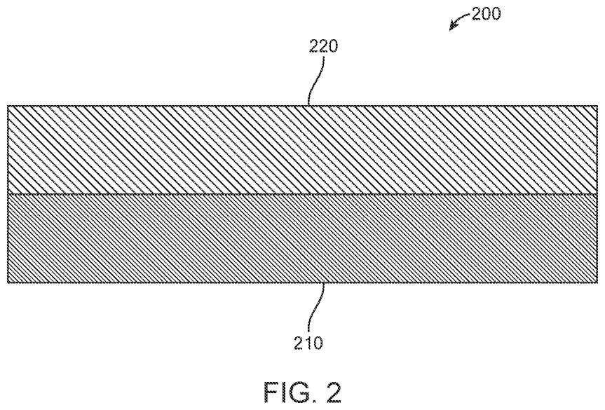

FIG. 2 through FIG. 5 illustrate a method of manufacturing contacts according to an embodiment of the present invention. In FIG. 2, a contact substrate 210 for contact 200, which can be used as contact 112 (shown in FIG. 1) can be received. The contact substrate 210 can be for a contact 122, or other contacts in other devices. Contact substrate 210 of contact 200 can be formed of copper, copper alloy, stainless steel, aluminum, or other material. Contact substrate 210 can be plastic with a layer of copper (not shown) or other material plated on a top surface. The plastic can have an affinity for a plating layer. For example, the plastic can be a thermoplastic polymer, such as acrylonitrile butadiene styrene or other material. An electrophoretic deposition coating 220 can be formed on a top surface of the contact substrate. The electrophoretic deposition coating 220 can be an epoxy, an acrylic, paint, or other material. The electrophoretic deposition coating 220 can include one or more pigments to provide electrophoretic deposition coating 220 with a desired color.

In these and other embodiments of the present invention, instead of using an electrophoretic deposition coating 220, other materials, such as conductive ink or other types of ink can be used. In these and other embodiments of the present invention, paint can be used. For example, a polymeric paint, such as a polytetrafluoroethylene (PTFE) based paint, can be used. These inks or paints can be applied using pad printing, ink-jet printing, 3-D printing, aerosol-jet printing, or other types of printing.

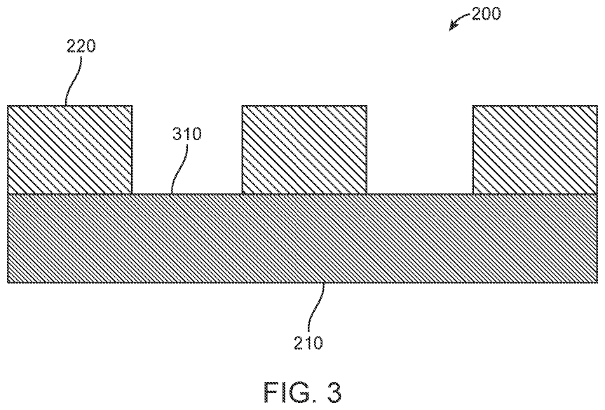

In FIG. 3, a number of holes 310 can be formed in electrophoretic deposition coating 220. These holes 310 can be formed in at least a portion of one or more surfaces of contact 200, for example along a top side of contact 200. These holes 310 can be formed in electrophoretic deposition coating 220 in various ways. Holes 310 can be sandblasted, chemically etched, formed using photolithography, laser etched, stamped, coined, 3-D printed, metal-injection molded, printed, cast, or they can be formed in other ways. Holes 310 can extend to a top surface of contact substrate 210.

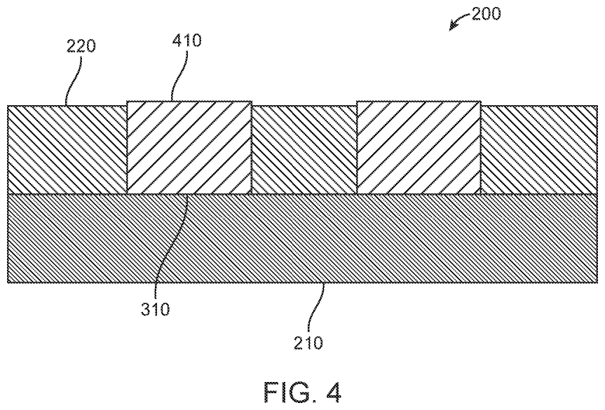

In FIG. 4, a number of pillars 410 can be formed by plating portions of contact substrate 210 exposed by holes 310. These pillars 410 can be formed of copper or other plating material. Each pillar 410 can be formed in a corresponding one of the holes 310. Pillars 410 can have various shaped cross-sections. For example, pillars 410 can have circular, square, oval, rectangular, or other shaped cross-sections. Pillars 410 can extend above the surrounding electrophoretic deposition coating 220 to form electrical connections with a corresponding contact on a second or accessory device. Contact 200 can also feel like metal since the pillars extend above the top surface of the electrophoretic deposition coating.

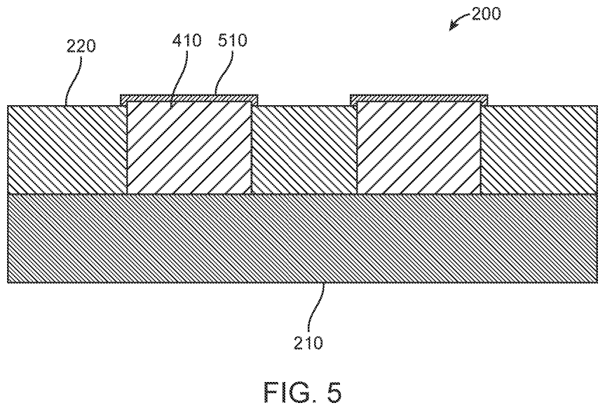

In FIG. 5, top surfaces of pillars 410 of contact 200 can be plated with one or more plating layers 510. Plating layers 510 can include a top plate that can be formed over pillar 410 to provide corrosion and scratch protection. This top plate can be formed of rhodium-ruthenium, rhodium-iridium, platinum-ruthenium, ruthenium, rhodium, or other material or combination of materials. The top plate can be formed of dark rhodium, where the rhodium is darkened through porosity. A barrier layer can be formed over pillar 410 before the top plate is formed to prevent discoloration of the top plate by the contact substrate 210. The barrier layer can be tin-copper, nickel, palladium, silver, tin-copper-nickel, copper-nickel, tin-nickel, nickel-tungsten, electroless nickel, or other material. One or more adhesion layers can be applied before or after the barrier layer, or both. These adhesion layers can be a gold flash or other layer. Other layers can also be included. For example, a layer of nickel-tungsten alloy, tin-nickel, electroless nickel, copper-nickel, silver, or other material can be plated or formed over the substrate before the barrier layer. Other combinations, such as a top plate of rhodium-ruthenium, rhodium-iridium, platinum-ruthenium, or other material or combination of materials over silver, palladium, nickel, electroless nickel, a nickel-tungsten alloy, tin-nickel, tin-copper, tin-copper-nickel, copper-nickel, tin-nickel, nickel-tungsten, or other nickel alloy can be used, where one or more gold layers can be included. Layers of gold over nickel can be used in these and other embodiments of the present invention. Additional steps, such as electro-polishing or copper plating can be performed on the substrate after the holes have been formed and before plating to smooth areas damaged by the laser. In these and other embodiments of the present invention, these layers can be formed by sputtering, vapor deposition, electroplating, or other method. By plating only the tops of pillars 410 with plating layers 510, the area to be plated can be reduced, thereby conserving resources such as precious metals.

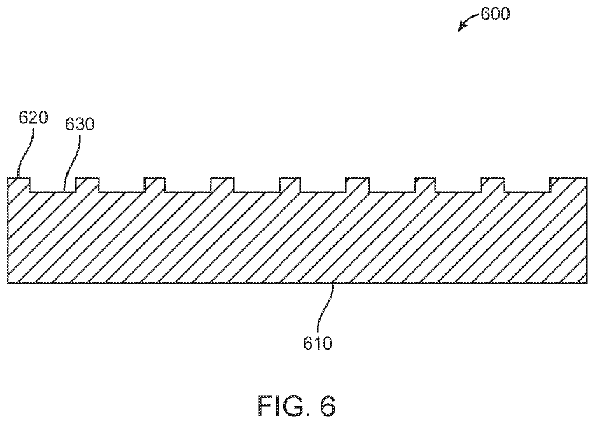

FIG. 6 through FIG. 9 illustrate another method of manufacturing contacts according to an embodiment of the present invention. In FIG. 6, a contact substrate 610 for contact 600, which can be used as contact 112 (shown in FIG. 1) can be received. The contact substrate 610 can be for a contact 122, or other contacts in other devices. Contact substrate 610 of contact 600 can be formed of copper, copper alloy, stainless steel, aluminum, or other material. Contact substrate 610 can be plastic with a layer of copper (not shown) or other material plated on a top surface. The plastic can have an affinity for a plating layer. For example, the plastic can be a thermoplastic polymer, such as acrylonitrile butadiene styrene or other material. A number of holes 630 can be formed in a top surface of contact substrate 610, leaving raised areas 620. Holes 630 can be sandblasted, chemically etched, formed using photolithography, laser etched, stamped, coined, 3-D printed, metal-injection molded, printed, cast, or they can be formed in other ways. Holes 630 can have various shaped cross-sections. For example, holes 630 can have circular, square, oval, rectangular, or other shaped cross-sections.

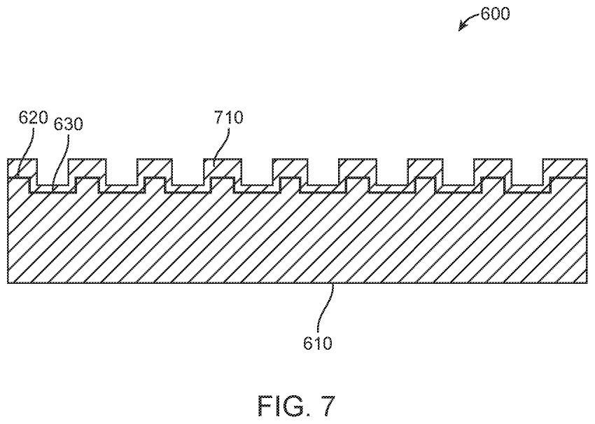

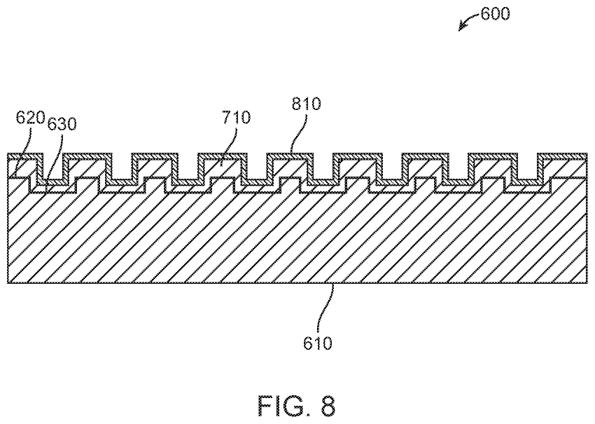

In FIG. 7, an optional layer, for example a copper layer 710 can be plated on a top surface of contact substrate 610. In FIG. 8, the top surface of contact substrate 610 can be plated with one or more plating layers 810. Plating layers 810 can include a top plate that can be formed over the top surface of contact substrate 610 to provide corrosion and scratch protection. This top plate can be formed of rhodium-ruthenium, rhodium-iridium, platinum-ruthenium, or other material or combination of materials. A barrier layer can be formed over the top surface of contact substrate 610 before the top plate is formed to prevent discoloration of the top plate by the contact substrate 610. The barrier layer can be tin-copper, nickel, palladium, silver, tin-copper-nickel, copper-nickel, tin-nickel, nickel-tungsten, electroless nickel, or other material. One or more adhesion layers can be applied before or after the barrier layer, or both. These adhesion layers can be a gold flash or other layer. Other layers can also be included. For example, a layer of nickel-tungsten alloy, tin-nickel, electroless nickel, copper-nickel, silver, or other material can be plated or formed over the substrate before the barrier layer. Other combinations, such as a top plate of rhodium-ruthenium, rhodium-iridium, platinum-ruthenium, or other material or combination of materials over silver, palladium, nickel, electroless nickel, a nickel-tungsten alloy, tin-nickel, tin-copper, tin-copper-nickel, copper-nickel, tin-nickel, nickel-tungsten, or other nickel alloy can be used, where one or more gold layers can be included. Layers of gold over nickel can be used in these and other embodiments of the present invention. Additional steps, such as electro-polishing or copper plating can be performed on the substrate after the holes have been formed and before plating to smooth areas damaged by the laser. In these and other embodiments of the present invention, these layers can be formed by sputtering, vapor deposition, electroplating, or other method.

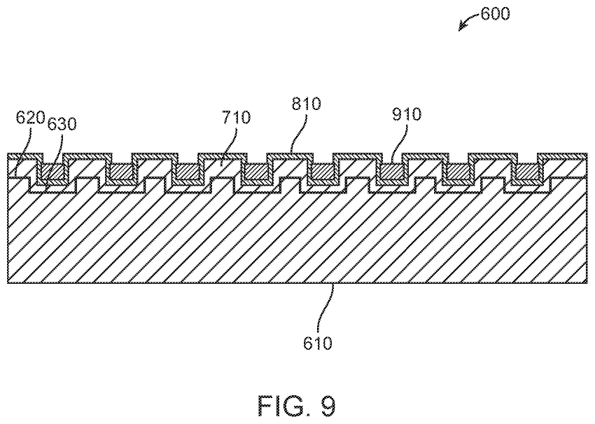

In FIG. 9, an electrophoretic deposition coating 910 can be formed on a top surface of the contact substrate 610. The electrophoretic deposition coating 910 can be an epoxy, an acrylic, paint, or other material. The electrophoretic deposition coating 910 can include one or more pigments to provide electrophoretic deposition coating 910 with a desired color. After electrophoretic deposition coating 910 is applied to a top surface of contact substrate 610, excess amounts can be wiped away to expose raised areas 620.

These steps can be done in a different order in these and other embodiments of the present invention. For example, some or all of the plating of the top plate and associated plating layers 810 can be done after the holes are filled with the electrophoretic deposition coating 910 and the excess has been removed. This can help to reduce an area of contact 600 to be plated thereby conserving resources such as precious metals.

In these and other embodiments of the present invention, instead of using an electrophoretic deposition coating 910, other materials, such as conductive ink or other types of ink can be used. In these and other embodiments of the present invention, paint can be used. For example, a polymeric paint, such as a polytetrafluoroethylene (PTFE) based paint, can be used. These inks or paints can be applied using pad printing, ink-jet printing, 3-D printing, aerosol-jet printing, or other types of printing.

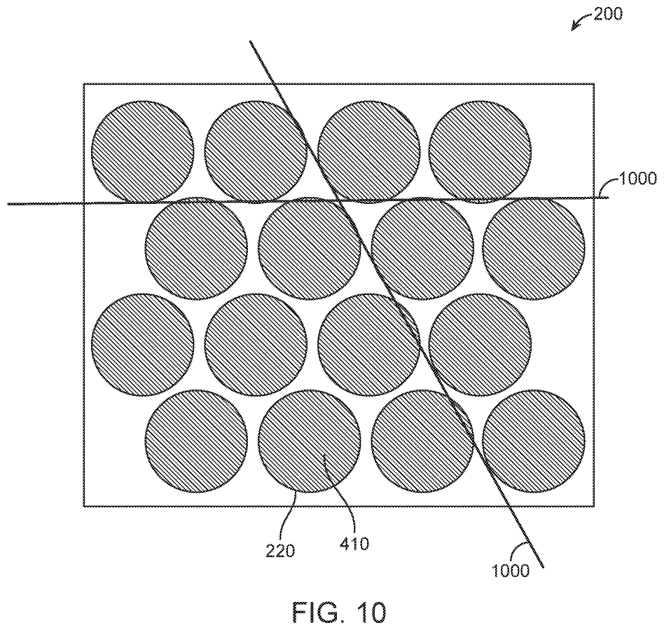

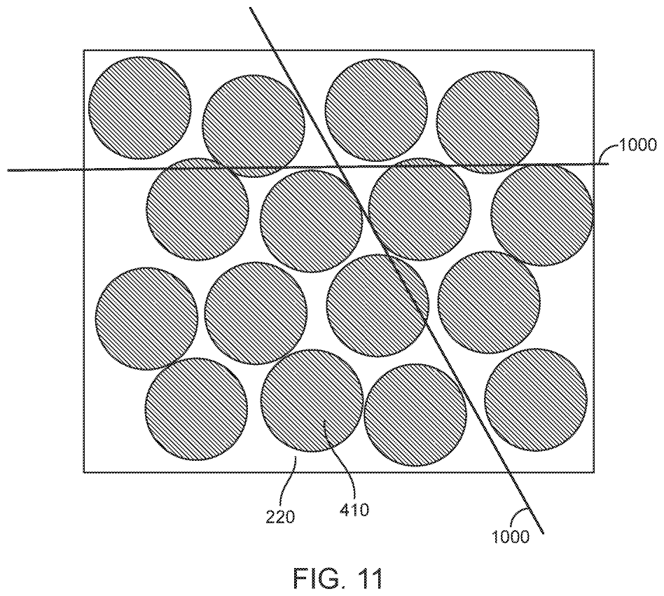

FIG. 10 and FIG. 11 illustrate a method of avoiding visible patterns on a surface of a contact according to an embodiment of the present invention. FIG. 10 illustrates lines 1000 that can be visible in a pattern of pillars 410 and surrounding electrophoretic deposition coating 220. To avoid the appearance of lines or other artifacts in the pattern of pillars 410, the locations of the pillars 410 can be varied or randomized, or more specifically pseudo-randomized. That is, the locations of pillars 410 formed in electrophoretic deposition coating 220 can be varied or randomized. For example, a laser can have a portion of its position information for some or all of pillars 410 varied or randomized in order to disperse straight lines or other regular patterns that might otherwise be visible. In FIG. 11, the locations or positions of pillars 410 have been varied to prevent artifacts along lines 1000.

Using these variations, a resulting pattern of pillars 410 can appear to be randomized and can have a reduced incidence of regular or repeating lines, patterns, or light or dark areas that can be observable. In these and other embodiments of the present invention, in order to avoid the appearance of lines, light or dark patches, or other artifacts, the diameters of pillars 410 can be varied or randomized. Also, pillars 410 can be omitted from areas or regions on contacts where such pillars 410 can interfere with further assembly or operation of the contacts. For example, where contacts are located in an injection molded housing, pillars 410 can be omitted from areas or regions that are under or near the injection molded housing.

In these and other embodiments of the present invention, pillars 410 can be arranged to provide a texture for contacts 200 that can match or be similar to a texture of a surrounding device enclosure (not shown.) That is, the laser pattern can be adjusted so that the texture of contacts 200 can provide an appealing effect when contacts 200 are put together with the surrounding material of the device enclosure. In these and other embodiments of the present invention, pillars 410 can be formed in the device enclosure as well as in the contacting surface of the contacts 200. In these and other embodiments of the present invention, pillars 410 can be arranged to provide other textures for contacts 200.

While FIG. 10 and FIG. 11 are explained in context of pillars 410 for contacts 200, these concepts can apply to holes 630 in contact 600.

While embodiments of the present invention are well-suited to electrical contacts and their method of manufacturing, these and other embodiments of the present invention can be used to improve the appearance and corrosion resistance of other structures. For example, electronic device cases and enclosures, connector housings and shielding, battery terminals, magnetic elements, measurement and medical devices, sensors, fasteners, various portions of wearable computing devices such as clips and bands, bearings, gears, chains, tools, or portions of any of these, can be covered with coatings, plating, and other layers as described herein and otherwise provided for by embodiments of the present invention. The coatings, plating, and other layers for these other structures can be formed or manufactured as described herein and otherwise provided for by embodiments of the present invention. For example, magnets and other structures for fasteners, connectors, speakers, receiver magnets, receiver magnet assemblies, microphones, and other devices can be improved by structures and methods such as those shown herein and in other embodiments of the present invention. Embodiments of the present invention can be utilized in various industries, including automotive, aerospace, electronics, and jewelry.

In these and other embodiments of the present invention, including the above contacts, other layers, such as barrier layers to prevent corrosion of internal structures can be included. For example, barrier layers, such as zinc barrier layers, can be used to protect magnets or other internal structures from corrosion by cladding or plating layers. Catalyst layers can be used to improve the rate of deposition for other layers, thereby improving the manufacturing process. These catalyst layers can be formed of palladium or other material. Stress separation layers, such as those formed of copper, can also be included in these and other embodiments of the present invention, including the above contacts. Other scratch protection, passivation, and corrosion resistance layers can also be included.

In various embodiments of the present invention, the contacts and their connector assemblies can be formed in various ways of various materials. For example, contacts and other conductive portions can be formed by stamping, coining, metal-injection molding, machining, micro-machining, 3-D printing, or other manufacturing process. The conductive portions can be formed of stainless steel, steel, copper, copper alloy, copper titanium, phosphor bronze, palladium, palladium silver, or other material or combination of materials, as described herein. They can be plated or coated with nickel, gold, palladium, rhodium, ruthenium, or other material, as described herein. They can be plated with dark rhodium, where the rhodium is darkened through porosity. The nonconductive portions can be formed using injection or other molding, 3-D printing, machining, or other manufacturing process. The nonconductive portions can be formed of silicon or silicone, Mylar, Mylar tape, rubber, hard rubber, plastic, nylon, elastomers, liquid-crystal polymers (LCPs), ceramics, or other nonconductive material or combination of materials.

Embodiments of the present invention can provide contacts and their connector assemblies that can be located in, and can connect to, various types of devices, such as portable computing devices, tablet computers, desktop computers, laptops, all-in-one computers, wearable computing devices, cell phones, smart phones, media phones, storage devices, keyboards, covers, cases, portable media players, navigation systems, monitors, power supplies, adapters, remote control devices, chargers, and other devices. These contacts and their connector assemblies can provide pathways for signals that are compliant with various standards such as Universal Serial Bus (USB), High-Definition Multimedia Interface (HDMI), Digital Visual Interface (DVI), Ethernet, DisplayPort, Thunderbolt, Lightning®, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these interconnect paths provided by these connectors can be used to convey power, ground, signals, test points, and other voltage, current, data, or other information.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A method of manufacturing an electrical contact, the method comprising:
receiving a contact substrate;
forming a coating layer over a top surface of the contact substrate;
forming a plurality of holes in the coating layer, the holes extending to a top layer of the contact substrate; and
plating the plurality of holes in the top surface of the contact substrate to form a plurality of pillars.

2. The method of claim 1 further comprising plating at top surface of each of the plurality of pillars.

3. The method of claim 2 wherein the contact substrate comprises copper.

4. The method of claim 2 wherein the contact substrate comprises a plating layer over plastic.

5. The method of claim 2 wherein the coating layer comprises an electrophoretic deposition coating.

6. The method of claim 5 wherein the electrophoretic deposition coating comprises an epoxy.

7. The method of claim 5 wherein the electrophoretic deposition coating comprises an acrylic.

8. The method of claim 5 wherein plating the plurality of pillars comprises plating a surface of each pillar with palladium, applying a gold flash to the palladium, and plating the gold flash with one of rhodium, rhodium-ruthenium, or platinum-ruthenium.

9. The method of claim 8 wherein the plurality of pillars are formed at locations, where the locations are varied from a regular, repeating pattern by an amount that is varied.

10. The method of claim 9 wherein the location of each of the plurality of pillars in the plurality of pillars is varied from a regular, repeating pattern by a first amount in a first and a second amount in a second direction, wherein the first amount and the second amount are varied among the plurality of pillars.

11. The method of claim 9 wherein a width of a first pillar in the plurality of pillars is varied as compared to a width of a second pillar in the plurality of pillars.

12. An electrical contact for an electronic device, the electrical contact comprising:
a contact substrate;
a coating layer over the contact substrate, the coating layer having a plurality of holes; and
a plurality of pillars, each pillar formed in a corresponding one of the plurality of holes.

13. The electrical contact of claim 12 further comprising a plating layer on a top surface of each of the plurality of pillars.

14. The electrical contact of claim 13 wherein the coating layer comprises an electrophoretic deposition coating.

15. The electrical contact of claim 14 wherein the electrophoretic deposition coating comprises a pigment such that a color of the electrical contact matches a color of a surrounding portion of an enclosure for the electronic device.

16. The electrical contact of claim 14 wherein the electrophoretic deposition coating comprises a pigment such that a color of the electrical contact contrasts with a color of a surrounding portion of an enclosure for the electronic device.

17. A method of manufacturing an electrical contact, the method comprising:
receiving a contact substrate;
forming a plurality of holes in a top surface of the contact substrate;
forming a coating layer the top surface of the contact substrate; and
removing excess coating layer from the top surface of the electrical contact substrate such that the coating layer remains in the holes in the top surface of the contact substrate.

18. The method of claim 17 further comprising, before forming the coating layer the top surface of the contact substrate, plating the top surface of the contact substrate.

19. The method of claim 17 further comprising, after removing excess coating layer from the top surface of the contact substrate, plating the top surface of the contact substrate.

20. The method of claim 17 wherein the coating layer comprises an electrophoretic deposition coating.
